(19) United States
(12) Patent Application Publication
(10) Pub. No.: US 2012/0175972 A1
(43) Pub. Date: Jul. 12, 2012

(54) SYSTEM AND METHOD FOR BATTERY SAVER

(76) Inventor: Guo Qing REN, Dongguan (CN)

(21) Appl. No.: 13/340,328

(22) Filed: Dec. 29, 2011

Related U.S. Application Data
(60) Provisional application No. 61/428,408, filed on Dec. 30, 2010.

(51) Int. Cl. H02J 7/00

(52) U.S. Cl. 307/130

(57) ABSTRACT

A battery saver device including a microcontroller that measures a voltage of a battery; a battery control module coupled to the microcontroller and including one or more transistors that electronically connect a device load to the battery when the transistors are in an active mode, and the microcontroller is further provided to turn off the transistors when the voltage of the battery falls below a predetermined threshold voltage.

### CROSS REFERENCE TO RELATED APPLICATIONS

This application claims priority to U.S. Provisional Application No. 61/428,408, entitled SYSTEM AND METHOD FOR BATTERY SAVER and filed Dec. 30, 2010, the contents of which are incorporated herein by reference into the present application.

### BACKGROUND

This invention relates generally to vehicle batteries, and more particularly, to a battery saving system and method for preventing over discharge of a vehicle battery.

Most vehicles include a battery for powering electrical loads. Typically, the primary purpose of the battery is to power the ignition system for the vehicle's power source, such as an engine. The battery may also power electrical loads other than the vehicle's ignition system. For example, the battery may power interior lights, exterior lights, clocks, radios, consumer electronics and the like.

When the vehicle is turned off, some, or all, of these electrical loads may continue to drain the battery. For example, interior/exterior lights, radios, and/or consumer electronics may continue to drain battery power, even after the vehicle's ignition has been turned off. Discharge of the vehicle's battery while the ignition is off can be detrimental to the vehicle's functionality. Specifically, over discharge of a vehicle's battery may prevent the engine from starting if the battery does not have sufficient charge to power the ignition system.

Some known systems that facilitate protecting against battery drainage utilize circuitry that disconnects all of the electrical loads of the vehicle from the battery when the vehicle's power source is turned off. Typically, these systems utilize heavy duty relays as a switching mechanism. Heavy duty relays can be expensive, thereby increasing overall cost of the circuitry. These heavy duty relays are also larger in size, effectively reducing the amount of space for other components. Moreover, systems that employ these heavy duty relays generally have no way of detecting if a new electrical load is connected to the battery while the vehicle is turned off.

Accordingly, there is a need for a system and method that facilitates protecting and maintaining the charge within a vehicle battery using a less expensive and smaller switching mechanism for switching battery circuitry on and off. Additionally, there is a need for a system and method that can detect whether a new load is connected to the vehicle's battery while the vehicle is turned off.

### BRIEF DESCRIPTION OF THE DRAWINGS

FIGS. 1(a) and 1(b) illustrate installation of the battery saver system in accordance with exemplary embodiments.

FIG. 2 illustrates a detailed schematic of the battery saver system in accordance with an exemplary embodiment.

FIG. 3 illustrates a flowchart for a battery saving method in accordance with an exemplary embodiment.

FIG. 4 illustrates a flowchart for an interrupt program used with a reset button in accordance with an exemplary embodiment.

### DETAILED DESCRIPTION

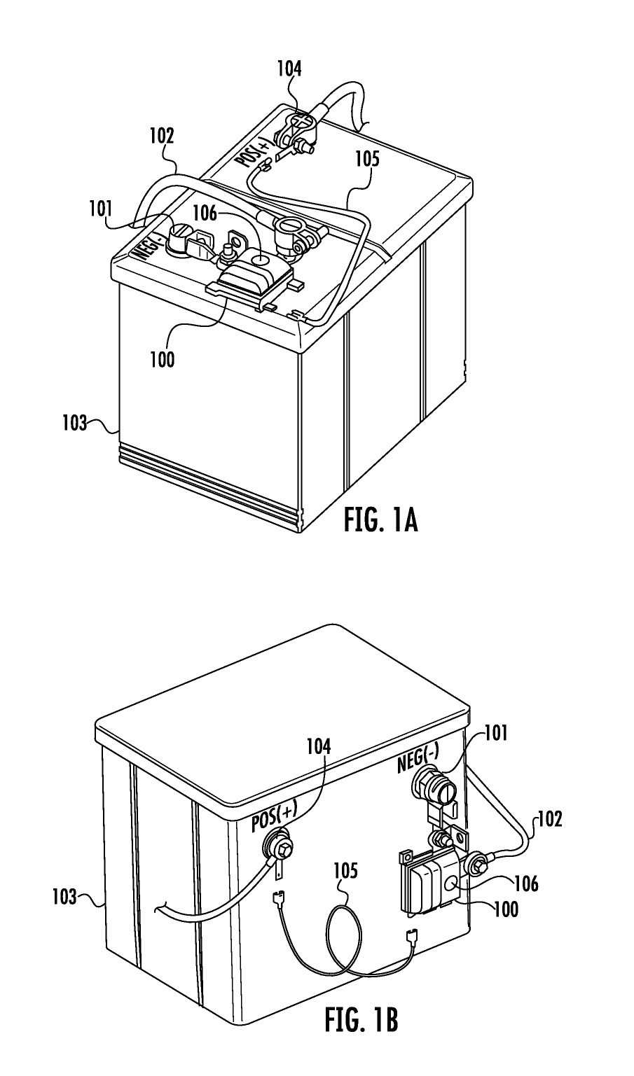

FIG. 1(a) illustrates battery saver device 100 installed on a top post battery. FIG. 1(b) illustrates a battery saver device 100 installed a side post battery. Since installation of battery saver device 100 on a side post battery is largely similar to installation on a top post battery, the two will be described together.

Installation of battery saver device 100 begins by disconnecting power cable 102 from negative battery terminal 101. Battery saver device 100 is then installed between negative battery terminal 101 and power cable 102. Power cable 102 is electrically connected to the vehicle's electrical and electronic components. The electrical connection between power cable 102 and battery saver device 100 will be referred to as node D. Clamps are used to firmly affix battery saver device 100 to both power cable 102 and negative battery terminal 101. Wire 105 is connected to positive battery terminal 104 to supply power for battery saver device 100. As FIGS. 1(a) and 1(b) illustrate, battery saver device 100 can be implemented with both top post and side post batteries. It should be appreciated that in an alternative embodiment, the battery saver device can be implemented internally inside the battery case 103, or mounted separately from battery case 103.

In the exemplary embodiment, battery saver device 100 supports both 12V and 24V batteries. However, it should be understood that the device can support any applicable type of battery. In the exemplary embodiment, battery saver device 100 draws less than 10 mA.

Battery saver device 100 can operate in hazardous environments, such as the engine compartment of an automobile. In the exemplary embodiment, battery saver device 100 is waterproof and can work in temperatures ranging from −40° F. to 185° F.

In the exemplary embodiment, battery saver device 100 uses metal oxide semiconductor field effect transistors (MOSFETs) to switch the battery circuitry on and off. These MOSFETs are soldered directly on to the metal terminals of battery saver device 100. By soldering the MOSFETs directly between the metal terminals, battery saver device 100 resolves any potential overheating problems to the printed circuit board (PCB) and MOSFETs. Such design can efficiently dissipate heat generated during engine start. An additional advantage is that MOSFETS, as opposed to mechanical switches, are also much smaller and more economical.

Once installation is complete, battery saver device 100 is provided and configured to continuously monitor battery voltage. When the battery voltage drops to a preset value, battery saver device 100 will switch off the MOSFETs between the battery's negative post 101 (BAT−) and power cable 102 (connected to node D). After the battery circuitry is switched off, battery saver device 100 will continue monitoring the load on power cable 102. When a device is connected to the battery circuitry, battery saver device 100 will sense the load change and automatically reconnect the MOSFETs, thereby reconnecting the battery to power cable 102. As described below with reference to one embodiment, a device is considered connected to the battery circuitry when an electrical component is turned on in a vehicle, such as by pressing the brake pedal or turning on the radio or lights.

As will be explained in more detail below, battery saver device 100 utilizes a microcontroller to control the on/off functionality of the battery circuitry. Battery saver device 100 uses a large capacitor to provide a stable voltage source to the gate of each MOSFET. This capacitor can maintain the MOSFETs in an on state (i.e., an active mode) during engine starting, even though the battery is flat and its voltage drops to a very low level.

In the exemplary embodiment, battery saver device 100 includes reset button 106. When battery saver device 100 is switched off, pressing reset button 106 will turn the MOSFETs on, electrically reconnecting the battery. When battery saver device 100 is switched on, pressing reset button 106 for more than a predetermined time period (e.g., 5 seconds) will switch off the MOSFETs, electrically disconnecting the battery.

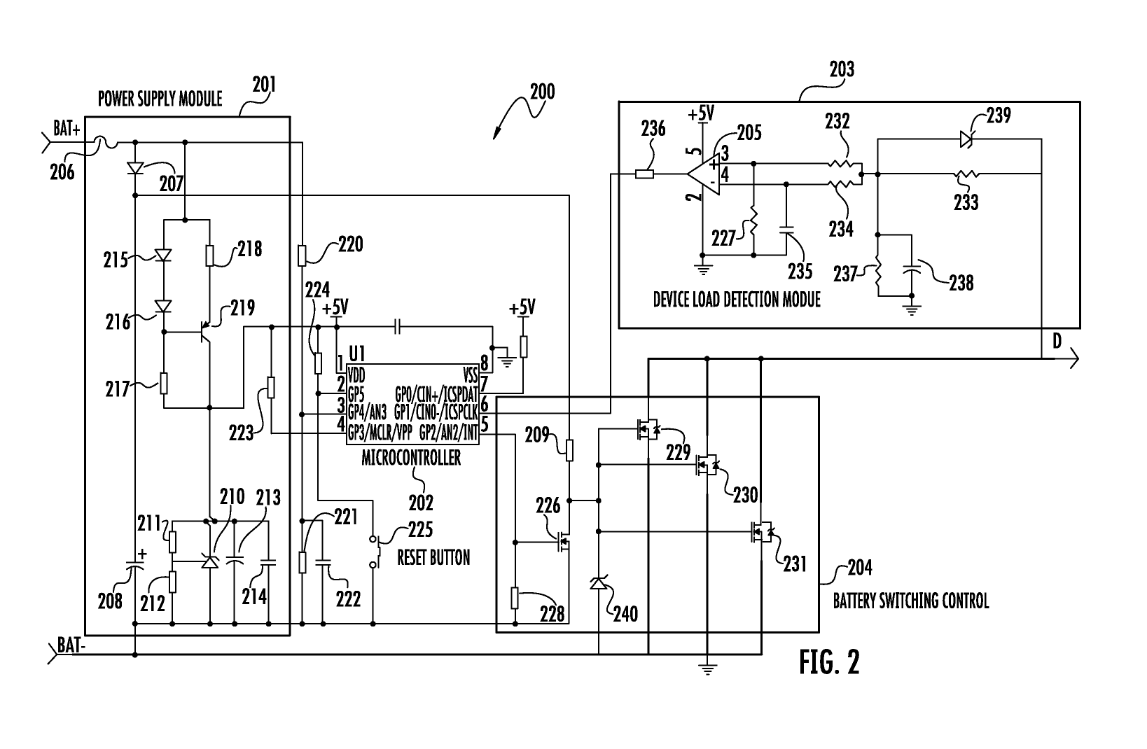

FIG. 2 shows a detailed schematic of battery saver device 200 in accordance with the exemplary embodiment. It should be appreciated that the detailed schematic of battery saver device 200 corresponds to battery saver device 100 as shown in FIG. 1 and described above. As shown in FIG. 2, battery saver device 200 includes power supply module 201 that provides a stable voltage supply to the battery saver circuitry. In particular, power supply module 201 provides a 5V power supply to microcontroller 202 and amplifier 205 (connections not shown). Power supply module 201 also provides an accurate reference voltage for load detection module 203. Input BAT+ is received from wire 105 connected to positive battery terminal 104 as shown in FIG. 1.

Fuse 206 is provided to protect the battery saver circuitry from overload. Diode 207 and capacitor 208 maintain a constant voltage at the gates of MOSFETs 229, 230 and 231 (through resistor 209). Furthermore, capacitor 208 is provided to maintain a high voltage level at the gates of MOSFETs 229, 230 and 231, forcing these MOSFETs to remain on when the battery voltage drops low during engine start.

Zener diode 210 is a shunt regulator that is configured to provide an accurate voltage source together with resistors 211 and 212, and capacitors 213 and 214.

Diodes 215 and 216, resistors 217 and 218, and transistor 219 collectively form a constant current source. This current source supplies a stable current input to microcontroller 202 over a wide range of battery voltage inputs. Resistors 220 and 221 and capacitor 222 collectively serve as a voltage divider, providing input to pin 3 of microcontroller 202. In the exemplary embodiment, microcontroller 202 is configured to measure the battery voltage accordingly. The reference voltage from power supply module 201 is connected through resistor 223 to pin 4 of microcontroller 202.

Resistor 224 and switch 225 are configured to provide a low level signal to pin 2 of microcontroller 202. It should be appreciated that switch 225 corresponds to reset button 106 as shown in the exemplary embodiments in FIG. 1a and FIG. 1b. When switch 225 is activated, a low level signal is sent to pin 2 of microcontroller 202. In response to this signal, microcontroller 202 either disconnects or reconnects the MOSFETs depending on the current state of the circuitry.

Battery saver device 200 further includes battery switching control module 204 that is provided and controlled by microcontroller 202. Battery switching control module 204 is configured to switch the battery circuitry ON and OFF. Transistor 226 is a switching transistor that operates with resistors 228 and 209. Transistor 226 is controlled by the output signal of pin 5 of microcontroller 202. When transistor 226 is on, the input at the gates of MOSFETs 229, 230 and 231 will be 0V such that those MOSFETs will be switched off, disconnecting electrical loads from the battery. When transistor 226 is off, the input at the gates of MOSFETs 229, 230 and 231 will be higher than 0V, switching those MOSFETs on, thereby electrically connecting electrical loads to the battery.

In the exemplary embodiment, transistors 229, 230 and 231 are the same type power MOSFETs that can withstand a very high current load. They are provided as a switch to the battery circuitry, which controls the connection from devices to the battery's negative terminal.

In the exemplary embodiment, battery saver device 200 also includes device load detection module 203 that is configured to sense when a new load is connected to the battery circuitry. When a new load is detected, device load detection module 203 will provide a high level signal to microcontroller 202. Amplifier 205 is used as a comparator in device load detection module 203. When there is a new device connected, the voltage at node D will increase. This voltage change will be transferred through resistors 232, 233, 234 and 227, and capacitor 235. The voltage change will begin charging capacitor 235. Before capacitor 235 is fully charged, there will be a voltage difference between pin 3 and pin 4 of comparator 205. This voltage difference will provide a high level output from comparator 205, which is then provided to pin 6 of microcontroller 202 indicating that a new load has been connected. This causes Microcontroller 202 pin 5 to output 0V, which turns on MOSFETS 229, 230 and 231, thereby reconnecting electrical loads to the battery. Resistor 237 is used to limit the voltage level at the input of comparator 205. Capacitor 238 acts a filter.

In an alternative embodiment, when battery saver device 200 is used with a 24V battery, Zener diodes 239 and 240 are configured to limit the voltage to ensure proper operation of the circuitry.

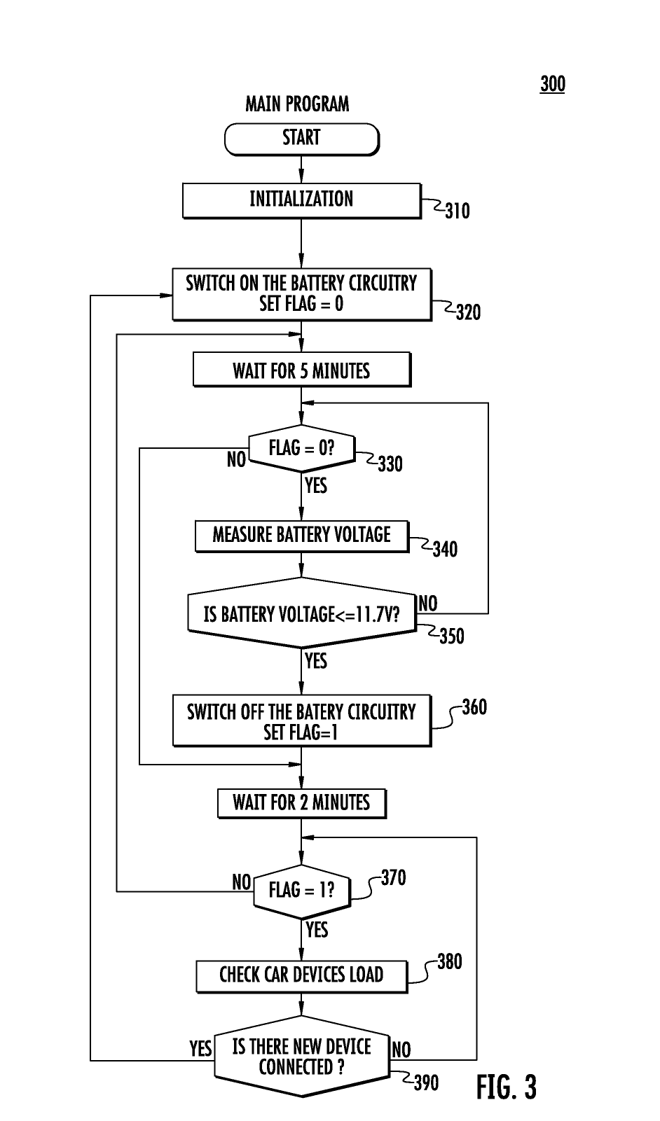

FIG. 3 illustrates shows a battery saving method 300 in accordance with an exemplary embodiment. For the exemplary method illustrated in FIG. 3, the battery saver device is designed to operate with a 12V vehicle battery. However, it should be understood that the battery saver device can support any applicable type of battery. Battery saving method 300 will be described with reference to the components of battery saver device 200 of FIG. 2.

In step 310, battery saving method 300 initializes microcontroller 202. In step 320, battery circuitry is switched on when microcontroller 202 provides a low level signal to the gate of transistor 226. When the gate of transistor 226 has a low level signal, the gates of the MOSFETs 229, 230, 231 in battery switching control module 204 are provided with high level signals. This switches on the MOSFETs 229, 230, 231, effectively connecting the battery circuitry. Once the battery circuitry has been connected, a flag in microcontroller 202 is set to 0 at which point battery saving device 200 times out for a predetermined time period (e.g., five minutes). In step 330, microcontroller 202 checks the value of the flag set in step 320. If the flag is 0, the method proceeds to step 340, where microcontroller 202 measures battery voltage from power supply module 201. If the value of the flag is 1, the method proceeds to step 370, which will be discussed in detail below.

In step 340, microcontroller 202 measures the battery voltage. Microcontroller 202 then compares the battery voltage to a preset value in step 350. In the exemplary embodiment, battery voltage is compared to 11.7V. If battery voltage is greater than 11.7V, the method returns to step 330. If battery voltage is less than or equal to 11.7V, battery saver device 200 proceeds to step 360. In step 360, battery circuitry is switched off by disconnecting the MOSFETs 229, 230, 231 in battery switching control module 204, and the flag value is set to 1 at which point the battery circuitry times out for another predetermined time period, such as two minutes in the exemplary embodiment. It should be appreciated that while 11.7 volts is described as the threshold voltage for the exemplary embodiment, battery saver device 200 and battery saving method 300 are by no way intended to be limited to this threshold voltage.

Next, at step 370, microcontroller 202 again checks the value of the flag. If the flag value is 0, indicating that the battery circuitry is switched on, the method returns to step 330, after the battery circuitry times out for five minutes. If the flag value is 1, indicating that the battery circuitry is switched off, the device will proceed to step 380, where it checks the car device load at node D.

Finally, at step 390, device load detection module 203 of battery saver device 200 determines whether a new device is connected to the battery circuitry. Specifically, load detection module 203 uses comparator 205 to determine whether a new load has been connected. If there is a sufficient difference in voltage between pin 3 and pin 4 of comparator 205, a high level signal is sent to microcontroller 202 pin 6 indicating a new load has been connected. If load detection module 203 detects a change in voltage at node D, then the device returns to step 320 where the battery circuitry is switched on. Alternatively, if load detection module 203 detects no change in voltage at node D, the device returns to step 370 where microcontroller 202 again checks the value of the flag.

Examples of a new device, or a new load, being connected to the battery circuitry include the driver stepping on the brake pedal, or switching on any other electrical device in the vehicle. These actions place a transient load on node D at step 390, which is detected by device load detection module 203, causing the method to return to step 320, which reconnects the battery for a period of time (e.g., 5 minutes) as described above with reference to FIG. 2. This period of time allows the driver time to try starting the vehicle. Also, the device load detection module allows the battery to be reconnected to the automobile circuitry without the need for the driver to leave the vehicle to reset the system.

It is again noted that FIG. 3 illustrates a battery saving method in accordance with a preferred embodiment. The method of the present invention does not necessarily have to be performed in the order described herein.

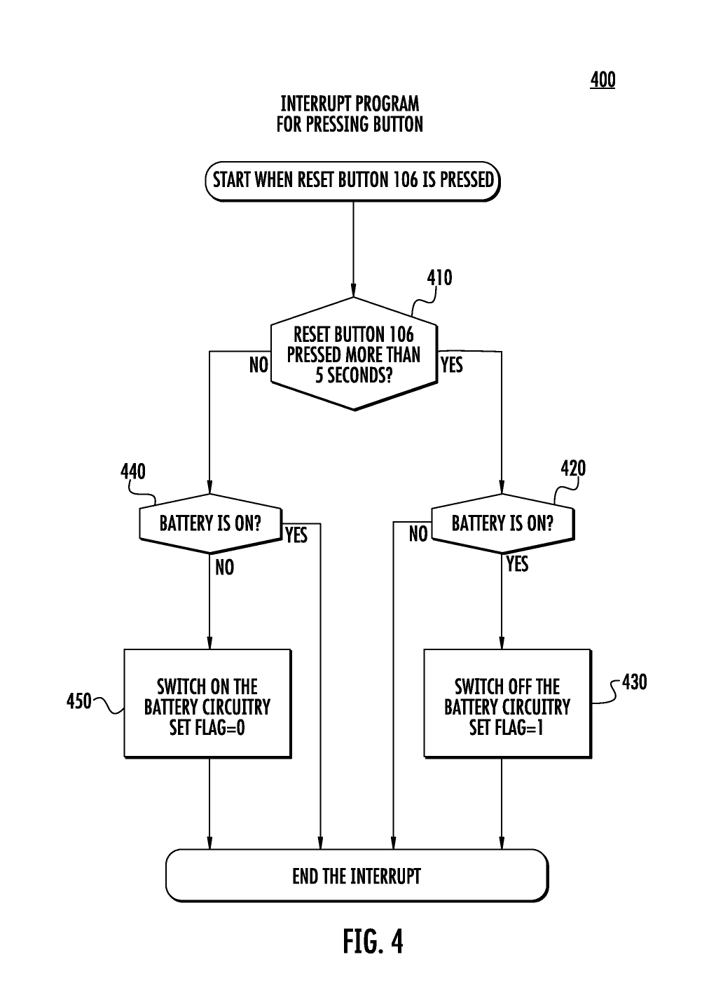

FIG. 4 illustrates operation of an interrupt program for use with a reset button in accordance with an exemplary embodiment. In the exemplary embodiment, interrupt program 400 begins when reset button 106 of battery saving device 100 is activated. In step 410, microcontroller 202 determines whether reset button 106 has been activated for more than a predetermined time period (e.g., five seconds). If reset button 106 has been activated for more than five seconds, interrupt program 400 proceeds to step 420 where microcontroller 202 determines whether the battery circuitry is on or off. If the battery circuitry is off, interrupt program 400 ends. If the battery circuitry is on, interrupt program 400 proceeds to step 430 where the battery circuitry is switched off by disconnecting the MOSFETs 229, 230, 231 in battery switching control module 204, and the flag value from battery saving method 300 is set to 1.

Referring back to step 410, if reset button 106 is not activated for more than a predetermined time period (e.g., five seconds), interrupt program 400 proceeds to step 440, where microcontroller 202 determines whether the battery circuitry is on or off. If the battery circuitry is on, interrupt program 400 ends. If the battery circuitry is off, interrupt program 400 proceeds to step 450, where the battery circuitry is switched on by connecting the MOSFETs in battery switching control module 203, and the flag value from battery saving method 300 is set to 0.

While the foregoing has been described in conjunction with an exemplary embodiment for a battery saver device and method, it is understood that the term “exemplary” is merely meant as an example, rather than the best or optimal. Accordingly, the application is intended to cover alternatives, modifications and equivalents, which may be included within the spirit and scope of the invention. For example, any device necessitating a minimum voltage level is intended to be within the scope of the application, including, but not limited to, automobile or nautical batteries.

Additionally, in the preceding detailed description, numerous specific details have been set forth in order to provide a thorough understanding of the present invention. However, it should be apparent to one of ordinary skill in the art that the present invention may be practiced without these specific details. In other instances, well-known methods, procedures, components, and circuits have not been described in detail so as not to unnecessarily obscure aspects of the present invention.

1. A battery saver device comprising:
a microcontroller configured to measure a voltage of a battery; and
a battery control module coupled to the microcontroller and having at least one transistor that electronically couples a load to the battery when the at least one transistor is in an active mode,
wherein the microcontroller is configured to turn off the at least one transistor when the voltage is below a threshold voltage.

2. The battery saver device of claim 1, further comprising a load detection module coupled to the microcontroller and configured to detect whether a load is connected to the battery.

3. The battery saver device of claim 2, wherein the load detection module comprises:
a comparator having a positive input and negative input each electrically coupled to the load; and
a capacitor coupled between the negative input and ground, the capacitor charging once the load is connected to the battery,
wherein the comparator outputs a signal based on the voltage difference between the positive input and the negative input.

4. The battery saver device of claim 3, wherein the microcontroller maintains the at least one transistor in active mode for a predetermined time period after receiving the high signal.

5. The battery saver device of claim 1, further comprising a power supply module coupled between the microcontroller and the battery and configured to provide a constant current source to the microcontroller.

6. The battery saver device of claim 5, further comprising a voltage divider coupled between the power supply module and the microcontroller.

7. The battery saver device of claim 1, further comprising a user-operated switch coupled to the microcontroller, wherein the switch causes the microcontroller to turn the at least one transistor off when actuated by a user.

8. The battery saver device of claim 1, wherein the at least one transistor is a MOSFET.

9. The battery saver device of claim 1, wherein the threshold voltage is approximately 11.7 volts.

10. The battery saver device of claim 1, wherein the battery saver device draws less than 10 mA.

11. The battery saver device of claim 1 wherein the at least one transistor is soldered to a first lead and a second lead,
wherein the first lead electrically couples the battery saver device to the battery, and the second lead electrically couples the battery saver device to an electrical load.

12. The battery saver device of claim 2 wherein the at least one transistor is soldered to a first lead and a second lead,
wherein the first lead electrically couples the battery saver device to the battery, and the second lead electrically couples the battery saver device to an electrical load.

13. A battery saver method comprising:
measuring, by a microcontroller, a voltage of a battery; and
forcing off at least one transistor, by the microcontroller, when the measured voltage is below a threshold voltage,
wherein the at least one transistor electronically couples a load to the battery when the at least one transistor is in an active mode.

14. The battery saver method of claim 13, further comprising detecting whether a load is connected to the battery.

15. The battery saver method of claim 14, further comprising maintaining the at least one transistor in active mode for a predetermined time period if the load is detected.

16. The battery saver method of claim 13, further comprising providing a constant current source to the microcontroller.

17. The battery saver method of claim 16, further comprising providing a voltage divider between the power supply module and the microcontroller.

18. The battery saver method of claim 13, further comprising receiving an input, via a switch, from a user.

19. The battery saver method of claim 18, further comprising:
determining whether the battery is on if the switch is activated by the user for at least a predetermined time period; and
forcing off the at least one transistor if the battery is determined to be on in the determining step.

20. The battery saver method of claim 18, further comprising:
determining whether the battery is on if the switch is activated by the user for less than a predetermined time period; and
forcing the at least one transistor to active mode if the battery is determined to be off in the determining step.

21. The battery saver method of claim 19 or 20, wherein the predetermined time period is approximately five seconds.

22. The battery saver method of claim 13, further comprising setting the threshold voltage to be approximately 11.7 volts.

23. The battery saver method of claim 13, further comprising soldering the at least one transistor to a first lead and a second lead,
wherein the first lead electrically couples the battery saver device to the battery, and the second lead electrically couples the battery saver device to an electrical load.
